(19) United States
(12) Patent Application Publication
(10) Pub. No.: US 2006/0132757 A1
(43) Pub. Date: Jun. 22, 2006

(54) System for measuring aberration, method for measuring aberration and method for manufacturing a semiconductor device

(76) Inventor: Takashi Sato, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/293,098

(22) Filed: Dec. 5, 2005

(30) Foreign Application Priority Data
Dec. 9, 2004 (JP) P2004-357273

(51) Int. Cl. G01B 9/00

(52) U.S. Cl. 356/124

(57) ABSTRACT

A method for measuring aberration includes: measuring a first optical property of a projection optical system before mounting the projection optical system to an exposure apparatus; mounting the projection optical system to the exposure apparatus; measuring a second optical property of the projection optical system after mounting the projection optical system to the exposure apparatus; and determining an amount of aberration of the projection optical system based on the first and second optical property.

### CROSS REFERENCE TO RELATED APPLICATIONS AND INCOORPORATED BY REFERRENCE

The application is based upon and claims the benefit of priority from the prior Japanese Patent Applications No. P2004-357273, filed on Dec. 9, 2004; the entire contents of which are incorporated herein by reference.

### BACKGROUND OF THE INVENTION

1. Field of the Invention

The present invention relates to a system and a method for measuring aberration, and a method for manufacturing a semiconductor device.

2. Description of the Related Art

In a manufacturing process for a semiconductor device, an exposure apparatus is used in which an image of a mask pattern of a photomask is projected through a projection optical system to a resist film applied on a wafer. The projection optical system of the exposure apparatus will have an aberration, and even a slight aberration adversely affects a device pattern. It is therefore important to measure the aberration of the projection optical system and reduce the influence of the aberration.

As a method of measuring the aberration of the projection optical system, there is a known method of an interferometric measurement before mounting the projection optical system to the exposure apparatus. Generally, wavefront aberration of the projection optical system is expressed by coefficients (Zernike coefficients) of respective terms of Zernike polynomials. The amount of aberration of the projection optical system is determined based on the Zernike coefficients, and the effect on the device pattern is estimated.

However, the amount of aberration of the projection optical system varies slightly when the projection optical system is mounted to the exposure apparatus. An aberration will exist, even if the exposure apparatus is adjusted after the projection optical system is mounted on the exposure apparatus, the adjustment being based on the amount of aberration determined before mounting the projection optical system on the exposure apparatus. Therefore the amount of aberration varies when the projection optical system is mounted and affects the device pattern. Moreover, it is difficult to perform the interferometric measurement after the projection optical system is mounted on the exposure apparatus because of limited space for interferometric measurement equipment and the like.

A known method of measuring the aberration, carried out after mounting the projection optical system to the exposure apparatus, delineates a pattern for aberration measurement in a resist film on a wafer and measures the size of a position gap of the pattern. However, in the method of measuring the size of the position gap, Zernike coefficients of higher order terms are less reliable in measurement accuracy than Zernike coefficients of lower order terms among the Zernike polynomials, leading to a problem of lower accuracy in aberration measurement.

### SUMMARY OF THE INVENTION

An aspect of the present invention inheres in a method for measuring aberration including: measuring a first optical property of a projection optical system before mounting the projection optical system to an exposure apparatus; mounting the projection optical system to the exposure apparatus; measuring a second optical property of the projection optical system after mounting the projection optical system to the exposure apparatus; and determining an amount of aberration of the projection optical system based on the first and second optical property.

Another aspect of the present invention inheres in a system for measuring aberration including: an exposure apparatus; a first measurement tool configured to measure a first optical property of a projection optical system before mounting the projection optical system to the exposure apparatus; a second measurement tool configured to measure a second optical property of the projection optical system after mounting the projection optical system to the exposure apparatus; and a determination module configured to determine an amount of aberration of the projection optical system based on the first and second optical property.

An additional aspect of the present invention inheres in a method for manufacturing a semiconductor device, including: determining an amount of aberration of a projection optical system based on an optical property of the projection optical system before and after mounting the projection optical system to an exposure apparatus; adjusting the projection optical system based on the amount of aberration; coating a resist film on a wafer; projecting an image of a mask pattern to a resist film, using the exposure apparatus with the adjusted projection optical system.

### BRIEF DESCRIPTION OF DRAWINGS

FIG. 1 is a block diagram showing an example of a system for measuring aberration according to an embodiment of the present invention.

FIG. 2 is an image of interference fringes of a projection optical system by interferometric measurement according to the embodiment of the present invention.

FIG. 3 is a plan view showing an example of a photomask according to the embodiment of the present invention.

FIG. 4 is a plan view showing an example of a reference mask pattern according to the embodiment of the present invention.

FIG. 5 is a sectional views showing an example of the reference mask pattern according to the embodiment of the present invention.

FIG. 6 is a plan view showing an example of a measurement mask pattern according to the embodiment of the present invention.

FIG. 7 is a sectional view showing an example of the measurement mask pattern according to the embodiment of the present invention.

FIG. 8 is a plan view showing an example of a wafer according to the embodiment of the present invention.

FIG. 9 is a sectional view showing an example of a wafer according to the embodiment of the present invention.

FIG. 10 is a chart showing values of Zernike coefficients according to the embodiment of the present invention.

FIG. 11 is a flow chart for explaining an example of a method for measuring aberration according to the embodiment of the present invention.

FIG. 12 is an image of interference fringes of the projection optical system based on a determined amount of aberration according to the embodiment of the present invention.

FIG. 13 is a flow chart for explaining an example of a method for manufacturing a semiconductor device according to the embodiment of the present invention.

### DETAILED DESCRIPTION OF THE INVENTION

An embodiment and a modification of the present invention will be described with reference to the accompanying drawings. It is to be noted that the same or similar reference numerals are applied to the same or similar parts and elements throughout the drawings, and the description of the same or similar parts and elements will be omitted or simplified.

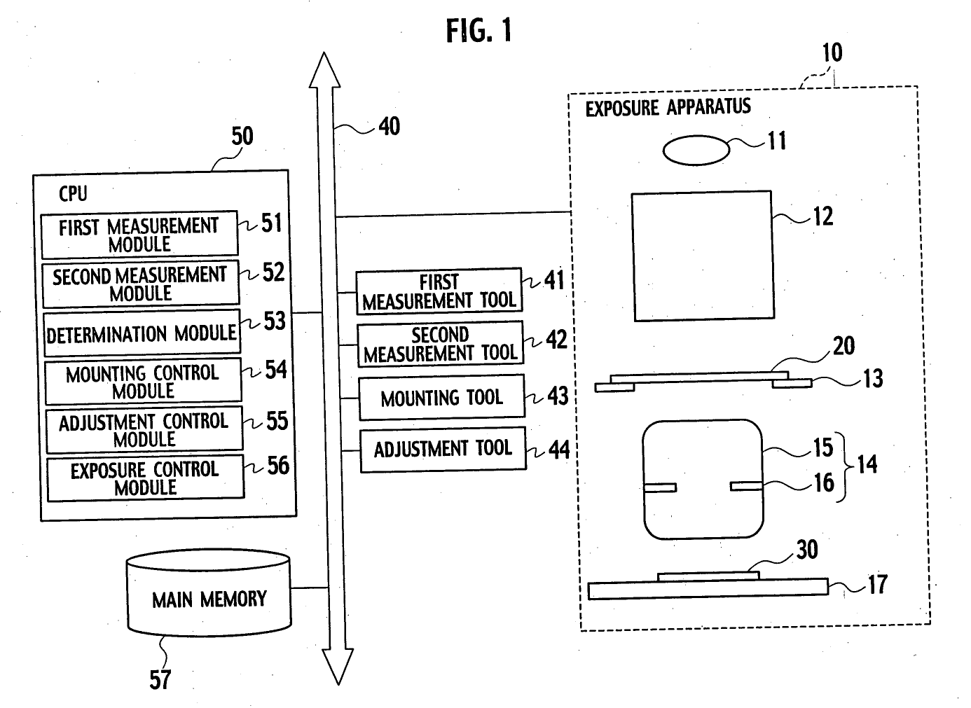

As shown in FIG. 1, a system for measuring aberration according to an embodiment of the present invention includes an exposure apparatus 10, a first measurement tool 41, a second measurement tool 42, a mounting tool 43, an adjustment tool 44, a central processing unit (CPU) 50, and a main memory 57.

The exposure apparatus 10 is, for example, a stepper with a reduction ratio of 4/1. Although the reduction ratio is given as 4/1, the ratio is arbitrary and not limited thereto. The exposure apparatus 10 includes a light source 11, an illumination optical system 12, a mask stage 13, a projection optical system 14, and a wafer stage 17. The light source 11 can be an argon fluoride (ArF) excimer laser with a wavelength λ of 193 nm and the like. The illumination optical system 12 includes a fly's eye lens and a condenser lens. The projection optical system 14 includes a projection lens 15 and an aperture stop 16.

The projection optical system 14 may have an aberration (lens error) such as spherical aberration, astigmatism, coma, distortion, wavefront aberration, and chromatic aberration. An expression representing the wavefront aberration is expanded into a series. The expression indicates different effects depending on the order of the components: higher order components represent local flare and higher order aberrations and lower order components represent lower order aberrations.

The wavefront aberration of the projection optical system 14 can be expressed by polynomials representing a system of orthogonal functions, such as Zernike polynomials. The wavefront aberration can be divided into many types of aberrations including a defocus term, a spherical aberration term, and the like by the terms of the Zernike polynomials.

The first measurement tool 41 can be an interferometer such as a Mach-Zehnder interferometer or a Fizeaw interferometer. The first measurement tool 41 observes and measures, as a first optical property, interference fringes of the projection optical system 14 created by superimposing two separated light paths on each other.

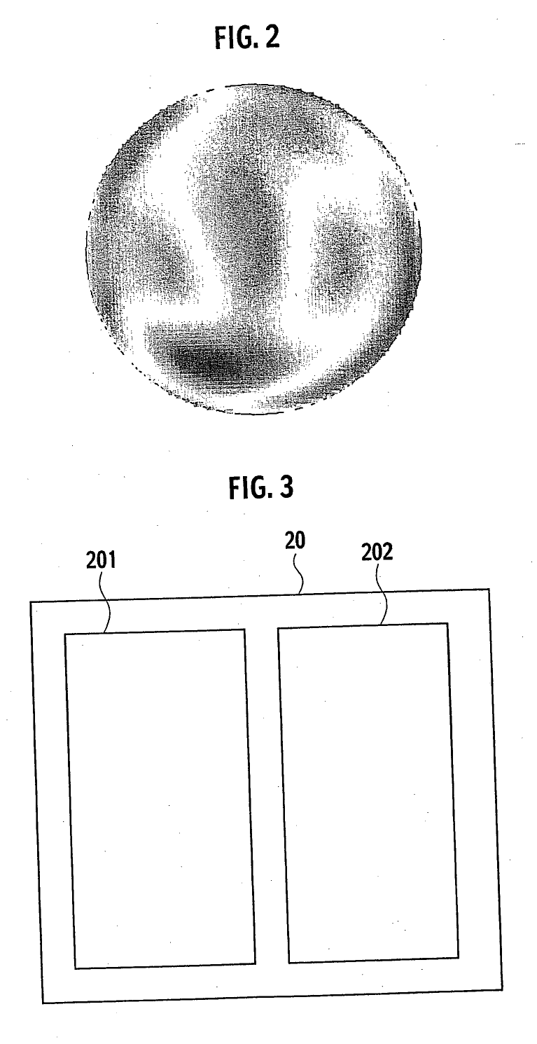

The interference fringes of the projection optical system 14, which is mounted on the exposure apparatus 10 (wavelength of the light source 11: 193 nm, numerical aperture: 0.68, reduction ratio: 4/1), are observed by the first measurement tool 41 as shown in FIG. 2. The first optical property, defined above, is stored in the main memory 57, shown in FIG. 1, as measurement data.

The mounting tool 43 mounts the projection optical system 14 to the exposure apparatus 10. In some cases, the aberration of the projection optical system 14 varies when the projection optical system 14 is mounted to the exposure apparatus 10.

At this time, among components of the aberration, components corresponding to higher order terms of the Zernike polynomials are less likely to vary than components corresponding to lower order terms, and only the components corresponding to the lower order terms vary. Herein, the “lower order terms” are the first to 10th terms Z1 to Z10, and the “higher order terms” are the 11th to 37th terms Z11 to Z37. However, the boundary between the lower order terms and the higher order terms is properly selected arbitrarily. The higher order terms may further include terms of higher order than that of the 37th term.

In the exposure apparatus 10, light is emitted from the light source 11 to reduce and project a pattern of a photomask 20, mounted on the mask stage 13 between the illumination optical system 12 and the projection optical system 14, to a wafer 30 on the wafer stage 17.

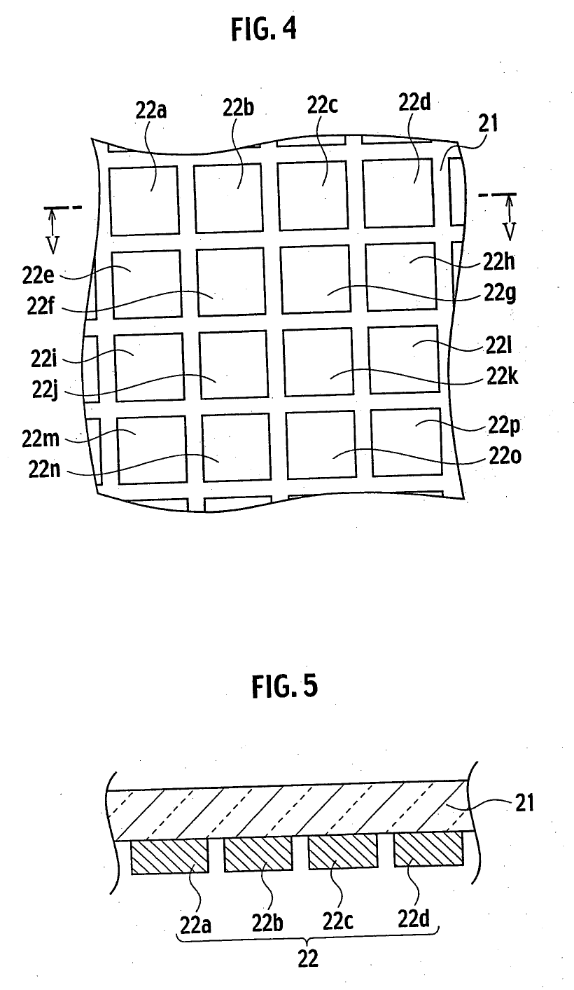

As shown in FIG. 3, the photomask 20 includes a reference mask pattern 201 and a measurement mask pattern 202. As shown in FIGS. 4 and 5, the reference mask pattern 201 includes light shielding portions 22a to 22p of chromium (Cr) or the like which are disposed on a transparent substrate 21 of quartz or the like. The light shielding portions 22a to 22p are rectangular patterns arranged in a matrix.

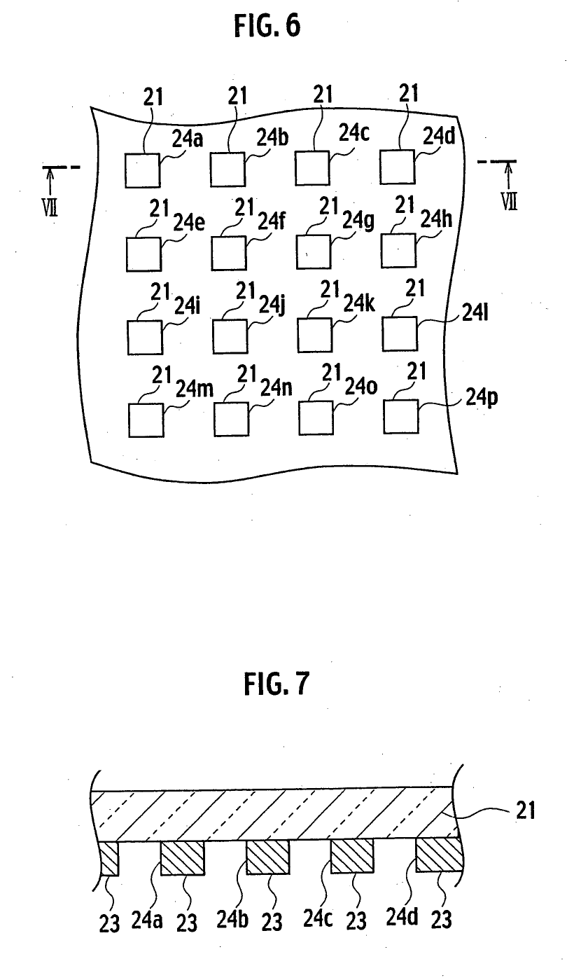

On the other hand, as shown in FIGS. 6 and 7, the measurement mask pattern 202 shown in FIG. 3 includes a light shielding portion 23 of Cr or the like disposed on the transparent substrate 21. The light shielding portion 23 includes openings 24a to 24p arranged in a matrix.

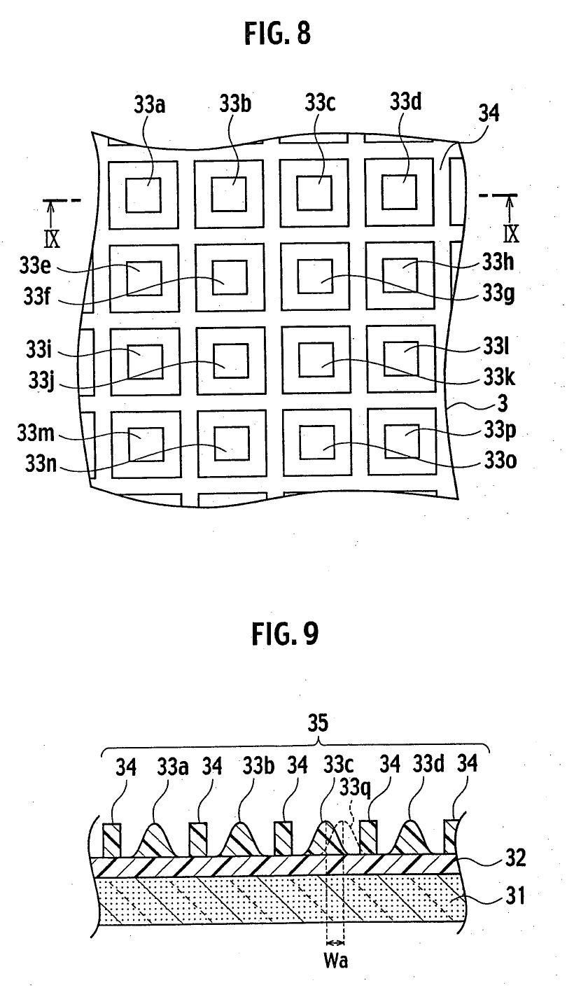

The reference mask pattern 201 and measurement mask pattern 202 of the photomask 20 are transferred to a negative resist film on the wafer 30 by double exposure. The resist film is then developed to delineate a resist pattern 35 shown in FIGS. 8 and 9.

The resist pattern 35 is disposed on a silicon nitride film (Si₃N₄ film) 32 placed on a silicon (Si) substrate 31 of or the like. The resist pattern 35 is a box-in-box pattern including rectangular measurement patterns 33a to 33p corresponding to the reference mask pattern 201 and a lattice-shaped reference pattern 34 corresponding to the measurement mask pattern 202. The lattice-shaped reference pattern 34 is arranged so as to surround the measurement patterns 33a to 33p. As shown in FIG. 9, for example, when a part of the projection optical system 14 on an optical path for forming the measurement pattern 33c includes an aberration, the position (target position) of the measurement pattern 33c is shifted by ΔWa to the position (actual position) of a measurement pattern 33q indicated by a dotted line.

The second measurement tool 42 shown in FIG. 1 can be an overlay inspection system comprising a CCD camera or the like. The second measurement tool 42 measures the amounts of position gaps between the target position and the actual position of the individual measurement patterns 33a to 33p, based on the positional relationship of the measurement pattern 33c to the reference pattern 34 shown in FIG. 9, as a second optical property. The measured second optical property is stored in the main memory 57 as measurement data.

The CPU 50 includes a first calculation module 51, a second calculation module 52, a determination module 53, a mounting control module 54, an adjustment control module 55, and an exposure control module 56.

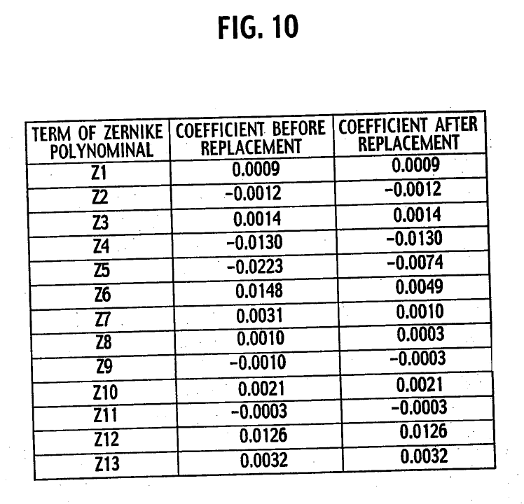

Based on the first optical property measured by the first measurement tool 41, the first calculation module 51 calculates Zernike coefficients a1 to a37 of the first to 37th terms Z1 to Z37 of the Zernike polynomials (first polynomials) in the projection optical system 14. The calculation is performed before mounting the projection optical system 14 on the exposure apparatus 10 as shown in before-replacement fields of FIG. 10, a part of which is omitted. The first calculation module 51 may calculate only the Zernike coefficients a11 to a37 of the higher order terms Z11 to Z37. Moreover, the first calculation module 51 may calculate Zernike coefficients of higher order terms equal to or higher than that of the 200th term by increasing the number of points of measurement of the first measurement tool 41.

The second calculation module 52 calculates Zernike coefficients b1 to b37 of the Zernike polynomials (second polynomials) in the projection optical system 14 after mounting the projection optical system 14 on the exposure apparatus 10 based on the second optical property measured by the second measurement tool 42. The second calculation module 52 may calculate only the Zernike coefficients b1 to b10 of the lower order terms Z1 to Z10 based on the second optical property measured by the second measurement tool 42.

For example, it is assumed that among the lower order terms Z1 to Z10, the Zernike coefficients b1 to b4 and b10 of the first to fourth terms Z1 to Z4 and the tenth term Z10 are equal to the Zernike coefficients a5 to a9 determined by the interferometric measurement, respectively, and the Zernike coefficients b5 to b9 of the fifth to ninth terms Z5 to Z9 are equal to about one third of the Zernike coefficients a5 to a9 determined by by the interferometric measurement, respectively.

Among the Zernike coefficients a1 to a37 measured by the first measurement tool 41, the determination module 53 that determines the amount of aberration replaces the Zernike coefficients a1 to a10 of the lower order terms Z1 to Z10 with the Zernike coefficients b1 to b10 of the lower order terms Z1 to Z10 measured by the second measurement tool 42 as shown in after-replacement fields of FIG. 10. The Zernike polynomials represent a system of orthogonal functions, and the terms Z1 to Z37 are independent of each other. Accordingly, the replacement of the value of each of the terms Z1 to Z37 of the Zernike polynomials does not affect the other terms.

Furthermore, the de termination module 53 determines the linear sum of the terms Z1 to Z37 of the Zernike polynomials (first and second polynomials) using the Zernike coefficients b1 to b10 of the Zernike polynomials (second polynomials) and a11 to a37 of the Zernike polynomials (first polynomials) as an amount of wavefront aberration of the projection optical system 14.

The mounting control module 54, adjustment control module 55, and exposure control module 56 control the mounting tool 43, adjustment tool 44, and exposure system 10, respectively.

The adjustment tool 44 adjusts a horizontal position, a focus position, exposure conditions, and the like of the projection optical system 14 of the exposure apparatus 10. The adjustment reduces the amount of wavefront aberration based on the amount of wavefront aberration determined by the determination module 53.

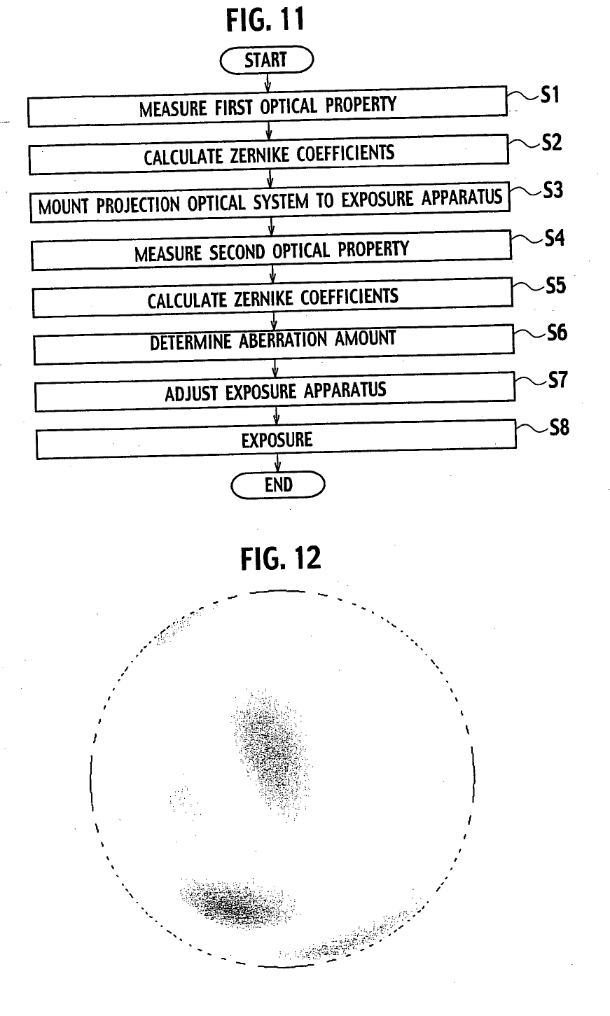

Next, a method for measuring aberration of the projection optical system 14 of the exposure apparatus 10 according to the embodiment of the present invention will be described, referring to the flow chart shown in FIG. 11.

In step S1, before mounting the projection optical system 14 to the exposure apparatus 10 shown in FIG. 1, the first measurement tool 41 measures a first optical property of the projection optical system 14 as shown in FIG. 2.

In step S2, the first calculation module 51 calculates Zernike coefficients a11 to a37 of the higher order terms Z11 to Z37 from among terms Z1 to Z37 of the Zernike polynomials (first polynomials), based on the first optical property measured in step S1.

In step S3, the mounting tool 43 mounts the projection optical system 14 to the exposure apparatus 10. Here, there is a case in which wavefront aberration of the projection optical system 14 is varied.

In step S4, a wafer 30, on which a negative resist film is coated, is fixed on the wafer stage 17 of the exposure apparatus 10. A photomask 20 is fixed on the mask stage 13. Using the exposure apparatus 10 comprising the projection optical system 14, an image of patterns of the photomask 20 are projected onto the negative resist film on the wafer 30. After developing the resist film, amounts of position gaps between the target position and the actual position of the aberration measurement patterns 33a to 33p are measured as a second optical property.

In step S5, the second calculation module 52 calculates Zernike coefficients b1 to b10 of the lower order terms Z1 to Z10 of the Zernike polynomials (second polynomials), based on the amounts of position gaps measured in step S4.

In step S6, the determination module 53 unifies the Zernike coefficients a11 to a37 of the higher order terms Z11 to Z37 of the first polynomials calculated in step S1 and the Zernike coefficients b1 to b10 of the lower order terms Z1 to Z10 of the second polynomials calculated in step S5, and determines the Zernike coefficients a11 to a37 and b1 to b10 as an amount of aberration.

In step S7, the adjustment tool 44 adjusts a position of the projection optical system 14, based on the amount of aberration determined in step S6.

In step S8, the exposure apparatus 10 conducts a properly adjusted exposure, using the projection optical system 14 as adjusted to a connected position in step S7.

Note that in step S1, the first calculation module 51 may further calculate Zernike coefficients a1 to a10 of the lower order terms Z1 to Z10 of the Zernike polynomials (first polynomials), in addition to the Zernike coefficients a11 to a37 of the higher order terms Z11 to Z37. In this case, in step S6, the amount of aberration is determined by replacing the Zernike coefficients a1 to a10 of the lower order terms Z1 to Z10 calculated in step S1 with the Zernike coefficients b1 to b10 of the lower order terms Z1 to Z10 calculated in step S5.

According to the embodiment of the present invention, the Zernike coefficients a11 to a37 are determined by the interferometric measurement performed for the projection optical system 14. The determination is made before the projection optical system 14 is mounted on the exposure apparatus 10, and the coefficients are used as the Zernike coefficients of the higher order terms Z11 to Z37 of the Zernike polynomials. Accordingly, it is possible to achieve highly reliable values.

Furthermore, the Zernike coefficients b1 to b10 are determined by the pattern transfer test performed after the projection optical system 14 is mounted on the exposure apparatus 10, and are used as the Zernike coefficients of the lower order terms Z1 to Z10 of the Zernike polynomials. Accordingly, it is possible to determine the amount of aberration by considering a variation in aberration of the projection optical system 14 when the projection optical system 14 is mounted to the exposure apparatus 10. Thus, using the combination of the Zernike coefficients a11 to a37 of the higher order terms Z11 to Z37 of the first polynomials, which are measured for the projection optical system 14 before the projection optical system 14 is mounted on the exposure apparatus 10, and the Zernike coefficients b1 to b10 of the lower order terms: Z1 to Z10 of the second polynomials, which are measured for the projection optical system 14 after the projection optical system 14 is mounted on the exposure apparatus 10, provides a highly accurate measurement of the aberration of the projection optical system 14.

FIG. 12 shows interference fringes representing the wavefront aberration of the projection optical system 14 obtained using the Zernike coefficients b1 to b10 and a11 to a37 after the replacement, as shown in the after-replacement fields of FIG. 10. It can be seen that the shade of interference fringes shown in FIG. 12 appear lighter than the shade of the interference fringes shown in FIG. 2.

Recent studies have revealed that the flare, which causes a problem during exposure, is represented by a Zernike coefficient of a term of higher order than that of the 200th term. An example of such studies is “Random Aberration and Local Flare” (M. Shibuya, et al.) announced in No. 5377-204, SPIE Microlithography 2004 (February 2004, at Santa Clara). The Zernike coefficient of the term of higher order than that of the 200th term is difficult to calculate using pattern transfer test.

According to the embodiment of the present invention, the term of higher order than that of the 200th term can be measured by using the result of the interferometric measurement. The combination of the Zernike coefficients b1 to b10 of the lower order terms Z1 to Z10, calculated by the pattern transfer test, and the Zernike coefficients a11 to a250 of the higher order terms Z11 to Z250, calculated by the interferometric measurement, provides prior evaluation of the effect on the device pattern in terms of both flare and aberration by simulation. Accordingly, it is possible to precisely predict an exposure apparatus with optimal conditions for exposure before an actual exposure.

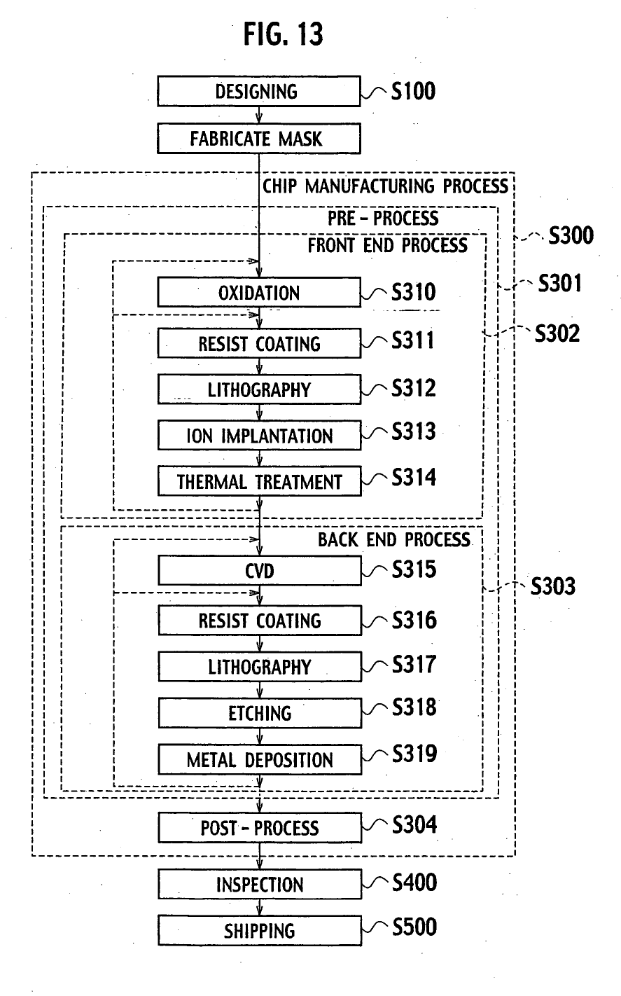

Next, a method for manufacturing a semiconductor device (LSI), referring to FIG. 13, will be explained. The manufacturing method described below is one example, and it is feasible to substitute modifications by various other manufacturing methods.

First, process mask simulation is carried out in step S100. Device simulation is performed by use of a result of the process mask simulation and each current value and voltage value to be input to each of the electrodes is set. Circuit simulation of the LSI is performed based on electrical properties obtained from the device simulation. Accordingly, layout data (design data) of device patterns is generated for each layer of the device layers corresponding to each stage in a manufacturing process.

In step S200, mask data of mask patterns is generated, based on design patterns of the layout data generated in step S100. Mask patterns are delineated on a mask substrate, and a photomask is fabricated. The photomask is fabricated for each layer corresponding to each step of the manufacturing process of an LSI to prepare a set of photomasks.

A series of processes including an oxidation process in step S310, a resist coating process in step S311, the photolithography process in step S312, an ion implantation process using a mask delineated in step S 312 in step S313, a thermal treatment process in step S314, and the like are repeatedly performed in a front-end process (substrate process) in step 302. Instead of steps S313 and S314, it is possible that selective etching is carried out using a mask fabricated in step S312. In this way, selective ion implantation and selective etching are repeatedly performed in step S302.

Prior to the procedure of step S312, interference fringes of the projection optical system 14 before mounting to the exposure apparatus 10 shown in FIG. 1 are measured as a first optical property. The projection optical system 14 is mounted to the exposure apparatus 10. The amounts of position gaps between the measurement patterns are measured as a second optical property of the projection optical system 14 by the pattern transfer test using the photomask 20. Zernike coefficients a1 to a37 are calculated in the projection optical system 14 before mounting the projection optical system 14 to the exposure apparatus 10, based on the first optical property. Zernike coefficients b1 to b37 are calculated in the projection optical system 14 after mounting the projection optical system 14 to the exposure apparatus 10, based on the second optical property. A linear sum of respective terms Z1 to Z37 is calculated using the Zernike coefficients a11 to a37 and the Zernike coefficients b1 to b10, and the linear sum is determined as an amount of aberration. A position of the projection optical system 14 is adjusted, based on the determined amount of aberration. In step S312, an image of mask patterns is projected to a resist film using the exposure apparatus 10 with the adjusted projection optical system 14, and resist patterns are delineated by developing the resist film. Various processes such as ion implantation in step S313, thermal treatment process in step S314, or a selective etching process and the like are performed. When the above-described series of processes are completed, the procedure advances to Step S303.

Next, a back-end process (surface wiring process) for wiring the substrate surface is performed in step S303. A series of processes including a chemical vapor deposition (CVD) process in step S315, a resist coating process in step S316, the photolithography process in step S317, a selective etching process using a mask fabricated by Step S317 in step S318, a metal deposition process to via holes and damascene trenches delineated in step S318 in step 319, and the like are repeatedly performed in the back-end process.

Prior to the lithography process of step S317, the same as in step S312, interference fringes (the first optical property) of the projection optical system 14 before mounting the projection optical system 14 to the exposure apparatus 10 are determined. The projection optical system 14 is mounted to the exposure apparatus 10. Amounts of position gaps between the measurement patterns are measured as the second optical property of the projection optical system 14, by the pattern transfer test with the photomask 20. Zernike coefficients a1 to a37 of the projection optical system 14 are determined before mounting the projection optical system 14 to the exposure apparatus 10, based on the first optical property. Zernike coefficients b1 to b37 of the projection optical system 14 after mounting the projection optical system 14 to the exposure apparatus 10 are determined, based on the second optical property. The linear sum of the Zernike coefficients a11 to a37 and the Zernike coefficients b1 to b10 is calculated, as an amount of aberration. A position of the projection optical system 14 is adjusted based on the determined amount of aberration. In this way, the procedure of step S317 is carried out so that an image of mask patterns are projected on a resist film by the exposure apparatus 10 with the adjusted projection optical system 14, and resist patterns are delineated by developing the resist film. Various wafer processes such as the etching process in step S318 are carried out by using the resist pattern as a mask. When the above-described series of processes are completed, the procedure advances to Step S304.

When a multilayer wiring structure is competed and the pre-process is finished, the substrate is diced into chips of a given size by a dicing machine such as a diamond blade in step S304. The chip is then mounted on a packaging material of metal, ceramic or the like. After electrode pads on the chip and leads on a leadframe are connected to one another, a desired package assembly process, such as plastic molding is performed.

In step S400, the semiconductor device is completed after an inspection of properties relating to performance and function of the semiconductor device, and other given inspections on lead shapes, dimensional conditions, a reliability test, and the like. In step S500, the semiconductor device which has cleared the above-described processes is packaged to be protected against moisture, static electricity and the like, and is then shipped out.

In steps S312 and S317, for example, it is assumed that twenty exposure apparatuses are provided in a factory. It is possible to easily set ten exposure apparatus from among the twenty exposure apparatuses to the same aberration property within a rule of predetermined pattern error, by adjusting the exposure apparatuses. The ten exposure apparatuses can be set to the same optical proximity correction (OPC) of a mask pattern for a trial product of a device of the leading edge technology. Therefore it is possible to transfer patterns to a wafer sing a mask with the same design.

Therefore it is possible to manufacture devices with high efficiency, and to improve manufacturing yield of a semiconductor device.

(Modification)

Next, a method for measuring aberration of the projection optical system 14 of the exposure apparatus 10 according to a modification of the embodiment of the present invention will be described, referring to FIG. 11.

In step S1, the first measurement tool 41 measures a first optical property of the projection optical system 14 before mounting the projection optical system 14 to the exposure apparatus 10. The measured first optical property is stored as measurement data in the main memory 57.

In step S2, the first calculation module 51 calculates Zernike coefficients a1 to a10 of the lower order terms Z1 to Z10 of the Zernike polynomials (first polynomials), based on the first optical property measured by the first measurement tool 41.

In step S3, the mounting tool 43 mounts the projection optical system 14 to the exposure apparatus 10.

In step S4, the wafer 30, on which a resist film is applied, is fixed on the wafer stage 17 of the exposure apparatus 10. The photomask 20 is fixed to the mask stage 13. In the exposure apparatus 10, an image of mask patterns of the photomask 20 is projected onto the resist film on the wafer 30. After developing the resist film, amounts of position gaps between the target position and the actual position of measurement patterns 33a to 33p are measured.

In step S5, the second calculation module 52 calculates Zernike coefficients b1 to b10 of the lower order terms Z1 to Z10 of the Zernike polynomials (second polynomials), based on the amounts of position gaps measured in step S3.

In step S6, the determination module 53 generates correction measurement data by substituting the Zernike coefficients a1 to a10 of the lower order terms Z1 to Z10, calculated in step S1, for the Zernike coefficients b1 to b10 of the lower order terms Z1 to Z10, calculated in step S5, and by setting to the measurement data of the first property.

In step S7, the adjustment tool 44 adjusts a position of the projection optical system 14, by using the correction measurement data as an aberration measurement value of the projection optical system 14.

In step S8, the exposure apparatus 10 provides a proper exposure using the projection optical system 14 of which the position is adjusted.

According to the modification of the embodiment of the present invention, by calculating the Zernike coefficients a1 to a10 of the lower order terms Z1 to Z10 in step S2, substituting the Zernike coefficients b1 to b10 of the lower order terms Z1 to Z10 in step S6, generating correction measurement data of which measurement data of the first optical property is corrected, and using the correction measurement data, in the same way as in the embodiment, it is possible to measure the aberration with high accuracy.

### Other Embodiments

Various modifications will become possible for those skilled in the art after receiving the teachings of the present disclosure without departing from the scope thereof.

In the embodiment of the present invention, the Zernike polynomials are explained as first and second polynomials of a system of orthogonal functions, however, various functions may also be used as the first and second polynomials of a system of orthogonal functions.

The resist film coated on the wafer 30 is described as a negative resist. A positive resist film may also be used as the photomask 30 by inverting the light shielding portions 22a to 22p shown in FIGS. 4 and 5, and the light shielding portion 23 shown in FIGS. 6 and 7.

In the method for measuring aberration shown in FIG. 11, after measuring the second optical property of step S4, the Zernike coefficients before mounting the projection optical system to the exposure apparatus 10, may be calculated based on the first optical property of step S2.

What is claimed is:

1. A method for measuring aberration comprising:
measuring a first optical property of a projection optical system before mounting the projection optical system to an exposure apparatus;
mounting the projection optical system to the exposure apparatus;
measuring a second optical property of the projection optical system after mounting the projection optical system to the exposure apparatus; and
determining an amount of aberration of the projection optical system based on the first and second optical property.

2. The method of claim 1, wherein measuring the first optical property comprises:
performing an interferometric measurement.

3. The method of claim 1, wherein measuring the second optical property comprises:
projecting an image of a mask pattern of a photomask to a resist film on a wafer using the exposure apparatus so as to delineate a measurement pattern of the resist film; and
measuring an amount of a position gap between an actual position and a target position of the measurement pattern.

4. The method of claim 1, wherein determining the amount of aberration comprises:
calculating coefficients of respective terms of first polynomials of orthogonal functions representing the amount of aberration of the projection optical system, before mounting the projection optical system to the exposure apparatus, based on the first optical property;
calculating coefficients of respective terms of second polynomials of orthogonal functions representing the amount of aberration of the projection optical system after mounting the projection optical system to the exposure apparatus, based on the second optical property; and
determining the amount of aberration using the coefficients of the first and second polynomials.

5. The method of claim 4, wherein calculating the coefficients of the first polynomials, comprises:
calculating the coefficients of higher order terms of the first polynomials.

6. The method of claim 5, wherein calculating the coefficients of the second polynomials, comprises:
calculating the coefficients of lower order terms of the second polynomials.

7. The method of claim 6, wherein determining the amount of aberration comprises:
determining a linear sum of the respective terms using the coefficients of the higher order terms of the first polynomials and the coefficients of the lower order terms of the second polynomials, as the amount of aberration.

8. The method of claim 4, wherein calculating the coefficients of the first polynomials comprises:
calculating the coefficients of lower order terms of the first polynomials.

9. The method of claim 8, wherein calculating the coefficients of the second polynomials comprises:
calculating the coefficients of lower order terms of the second polynomials.

10. The method of claim 9, wherein determining the amount of aberration comprises:
substituting each of the coefficients of the lower order terms of the first polynomials, for the coefficients of the lower order terms of the second polynomials; and
setting the coefficients of the lower order terms of the second polynomials to the first optical property.

11. The method of claim 4, wherein the first and second polynomials are Zernike polynomials.

12. A system for measuring aberration comprising:
an exposure apparatus;
a first measurement tool configured to measure a first optical property of a projection optical system before mounting the projection optical system to the exposure apparatus;
a second measurement tool configured to measure a second optical property of the projection optical system after mounting the projection optical system to the exposure apparatus; and
a determination module configured to determine an amount of aberration of the projection optical system based on the first and second optical property.

13. The system of claim 12, wherein the first measurement tool performs an interferometric measurement.

14. The method of claim 12, wherein the exposure apparatus projects an image of a mask pattern of a photomask to a resist film on a wafer so as to delineate a measurement pattern of the resist film; and
the second measurement tool measures an amount of a position gap between an actual position and a target position of the measurement pattern.

15. The system of claim 12, further comprising:
a first calculation module configured to calculate coefficients of respective terms of first polynomials of orthogonal functions representing the amount of aberration of the projection optical system, before mounting the projection optical system to the exposure apparatus, based on the first optical property; and
a second calculation module configured to calculate coefficients of respective terms of second polynomials of orthogonal functions representing the amount of aberration of the projection optical system, after mounting the projection optical system to the exposure apparatus, based on the second optical property,
wherein the determination module determine the amount of aberration using the coefficients of the first and second polynomials.

16. The system of claim 15, wherein the first calculation module calculates the coefficients of higher order terms of the first polynomials.

17. The system of claim 15, wherein the second calculation module calculates the coefficients of lower order terms of the second polynomials.

18. A method for manufacturing a semiconductor device, comprising:
determining an amount of aberration of a projection optical system based on an optical property of the projection optical system before and after mounting the projection optical system to an exposure apparatus;
adjusting the projection optical system based on the amount of aberration;
coating a resist film on a wafer;
projecting an image of a mask pattern to a resist film, using the exposure apparatus with the adjusted projection optical system.

19. The method of claim 18, wherein determining the amount of aberration comprises:
calculating coefficients of respective terms of polynomials of orthogonal functions representing the amount of aberration of the projection optical system before and after mounting the projection optical system to the exposure apparatus, respectively, based on the optical property; and
determining the amount of aberration using the coefficients.

20. The method of claim 18, wherein adjusting the projection optical system further adjusts another projection optical system which is different from the projection optical system of the exposure apparatus, based on the amount of aberration.
